(19) United States
(12) Patent Application Publication
(10) Pub. No.: US 2021/0001293 A1
(43) Pub. Date: Jan. 7, 2021

(54) Feed Mixer Assembly

(71) Applicant: OMNI USA, Inc., Houston, TX (US)

(72) Inventors: Jeffrey K. Daniel, Houston, TX (US); Vincenzo Vanni, Roncocesi (IT)

(21) Appl. No.: 16/916,472

(22) Filed: Jun. 30, 2020

Related U.S. Application Data
(60) Provisional application No. 62/869,774, filed on Jul. 2, 2019.

(51) Int. Cl. B01F 15/00; B01F 7/16; B01F 3/18; B01F 7/24; A23N 17/00; B01F 13/00

(52) U.S. Cl. CPC B01F 15/00538; B01F 7/1665; B01F 3/188; B01F 7/162; B01F 7/241; B01F 2015/00623; A23N 17/007; B01F 13/0037; B01F 2015/00597; B01F 2015/0061; B01F 2215/0008; B01F 15/00461

(57) ABSTRACT

A feed mixer vehicle having a hopper with a base is carried on a chassis. A vertically extending auger assembly is rotatably mounted in the hopper adjacent the base, extending from the hopper base. A reduction gearbox assembly having a reduction gear train assembly is mounted adjacent the base of the auger assembly. The reduction gear train assembly has an input shaft and an output shaft, with the output shaft coupled to the auger assembly. The reduction gearbox assembly further includes a first planetary gear set assembly meshed with a second planetary gear set assembly, where the first planetary gear set assembly includes the input shaft and the second planetary gear set assembly includes the output shaft. Coupled to the input shaft of the reduction gearbox assembly is an axial flux motor assembly.

### PRIORITY

This application claims priority to U.S. Provisional Application No. 62/869,774, filed Jul. 2, 2019, the benefit of which is claimed and the disclosure of which is incorporated by herein by reference in its entirety.

### FIELD OF THE INVENTION

This invention relates generally to the field of agricultural feed mixers and more particularly to vertical feed mixer drive systems.

### BACKGROUND

Agricultural feed mixers are utilized to provide a homogenous mixture of ingredients to be fed to livestock. One type of agricultural feed mixer is the vertical feed mixer. Vertical feed mixers typically include a hopper or mixing chamber within which is located a vertically oriented, helical auger. The auger has a central shaft with blades mounted along the periphery of the shaft. The blades may be a continuous spiraling extension which may also be referred to as a flighting. The shaft and/or the flighting may have an expanding periphery that is narrowest at a top and increases in size towards the base of the auger, which extends upward from the bottom of the mixing chamber.

The auger is typically powered using the power take off (PTO) of a tractor (in the case of trailered feed mixers) or truck (in the case of truck bed mounted feed mixers) and is connected to the vehicle by a suitable drive shaft. For tractors, traditionally this had been done by using a direct drive connection from the tractor's engine, through the PTO, to the auger. Variation in the speed of the auger in a direct drive arrangement is achieved by varying the speed of the tractor's engine. Where the feed mixer is incorporated into a vehicle such as a truck, the truck may include an additional transmission to separately control the drive axel of the truck and the operation of the feed mixer.

A right-angle gearbox is typically positioned below the auger and connected to the PTO in order to drive the auger. In the case of multiple augers, the gearbox also commonly passes through the power to subsequent right-angle gearboxes via a interconnecting drive shaft. It will be appreciated because of the high torque required to suitable drive the augers, the vehicle engine must operate in order to drive the auger.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a partial-cutaway elevation view of a feed mixer assembly of the disclosure.

FIG. 2A is perspective view of one embodiment of a gearbox and axial flux electric motor of the disclosure.

FIG. 2B is perspective view of another embodiment of a gearbox and axial flux electric motor of the disclosure.

FIG. 3A is an elevation view of a reduction gear train of the disclosure having multiple planetary gear sets.

FIG. 3B is an elevation view of another embodiment of a reduction gear train of the disclosure.

FIG. 4 is an elevation partial exploded view of a reduction gear train of the disclosure having multiple planetary gear sets.

FIG. 5 is a partial-cutaway elevation view of a gear train and axial flux motor mounted in a feed mixer assembly.

FIG. 6 is a cut-away side view of an embodiment of an axial flux motor assembly.

FIG. 7 is a plan view of the hopper of the feed mixer assembly of the disclosure.

### DETAILED DESCRIPTION OF THE EMBODIMENTS

Disclosed herein are embodiments of a feed mixer driven by an axial flux electric motor assembly with a low-profile reduction gear train assembly. In some embodiments, the feed mixer may be truck mounted, stationary or trailer mounted. The feed mixer includes one or more vertical auger assemblies positioned within a hopper and preferably extending up from the base of the hopper.

The auger assemblies may include a helical blade extending about an auger shaft. The reduction gear train assembly may include at least two reduction gearsets. In some embodiments, at least two planetary reduction gearset assemblies mesh with one another to form the reduction gear train assembly. In some embodiments, a first planetary reduction gearset meshes with a second planetary reduction gearset which meshes with a third planetary reduction gearset to form the reduction gear train assembly. In some embodiments, at least one reduction gearset is a parallel shaft reduction gear set and at least one reduction gearset is a planetary gear set, where the planetary gearset drives a hub to which the auger is attached. In some embodiments, the reduction gear train assembly has a first parallel reduction gear set, a second parallel reduction gear set and a planetary gear set. In some embodiments, the axial flux motor includes a rotor mounted on a rotatable drive shaft supported within a motor housing. Spaced apart from the rotor along the axis of the drive shaft is a stator. The rotor may include magnets placed about a circumference of the rotor. The stator may include windings positioned about a circumference of the stator. A gear on the driveshaft engages the first reduction gear set. In some embodiments the driveshaft gear engages the first reduction gear set; the first reduction gear set engages the second reduction gear set; and the second reduction gear set output shaft transfers rotary motion to the planetary gear set.

In one or more embodiments, the axial flux motor housing and the gearbox housing the gear train are attached to one another. In one or more embodiments, the axial flux motor and the gearbox housing are mounted on a base plate which base plate can be removably secured to the base of the hopper, thereby allowing the axial flux motor assembly and reduction gear train assembly to be readily installed and removed from a hopper as desired.

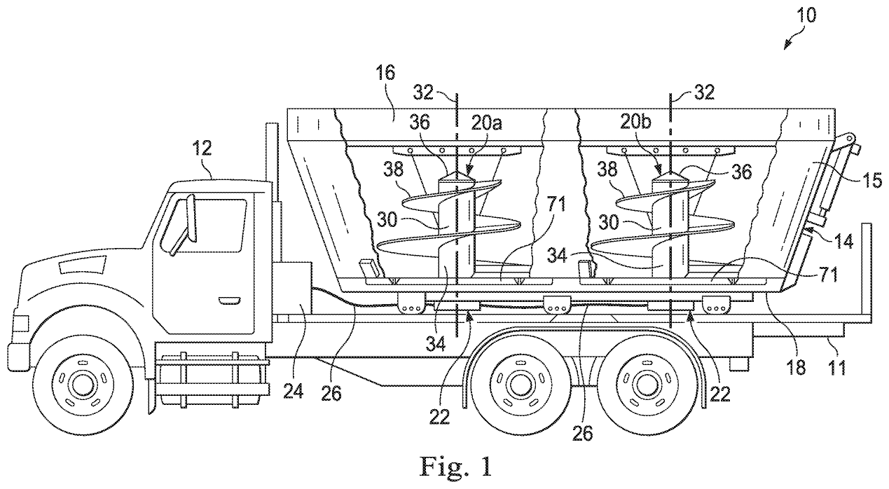

Turning to FIG. 1, a feed mixer assembly 10 is illustrated. The feed mixer assembly may be mounted on the chassis 11 of a vehicle 12, such as the illustrated truck. In other embodiments, feed mixer assembly 10 may be mounted on a trailer chassis or a stationary fixture. In any event, feed mixer assembly 10 generally includes a vessel or hopper 14 formed of a hopper wall 15 forming an opening 16 at the top of hopper 14 into which feed may be charged. Hopper 14 further includes a base 18 from which at least one vertically arranged auger assembly 20 extends. In the illustrated embodiment, two auger assemblies 20a, 20b are shown vertically extending from hopper base 18. Mounted below each auger assembly 20 is an auger drive assembly 22. In some embodiments, the auger drive assembly 22 is mounted to hopper base 18, while in other embodiments, auger drive assembly 22 may be mounted to a base plate 71 which is removably secured to hopper base 18. In any event, it will be appreciated that each auger drive assembly 22 is independent of the other auger drive assembly 22. Moreover, neither auger drive assembly 22 is mechanically driven, such as would be the case of prior art feed mixers driven by a PTO from the truck. Rather, an electrical power source 24 is utilized to supply electricity to each auger drive assembly 22 via cable 26. Electrical power source 24 may be any suitable power source, including without limitation batteries or a generator. In some embodiments, electrical power source 24 may be an electrical storage unit that is electrically charged during operation of the vehicle's engine. Electrical power source 24 may further include an inverter for powering auger drive assembly 22.

In any event, auger assembly 20 includes an auger shaft 30 extending along a vertical axis 32 and having a proximal end 34 adjacent the base 18 of hopper 14 and a distal end 36 extending toward opening 16 of hopper 14. Auger shaft 30 may be tapered, decreasing in diameter from the proximal end 34 to the distal end 36. At least one auger blade 38 extends from auger shaft 30. In some embodiments such as is shown, auger blade 38 may be a helical blade extending along at least a portion of the length of auger shaft 30. Likewise, as shown, in some embodiments, auger blade 38 my increase in its outer diameter along the length of auger shaft 30, such that blade 38 has a smaller diameter adjacent the distal end 36 of auger shaft 30 and a larger diameter adjacent the proximal end 34 of auger shaft 30.

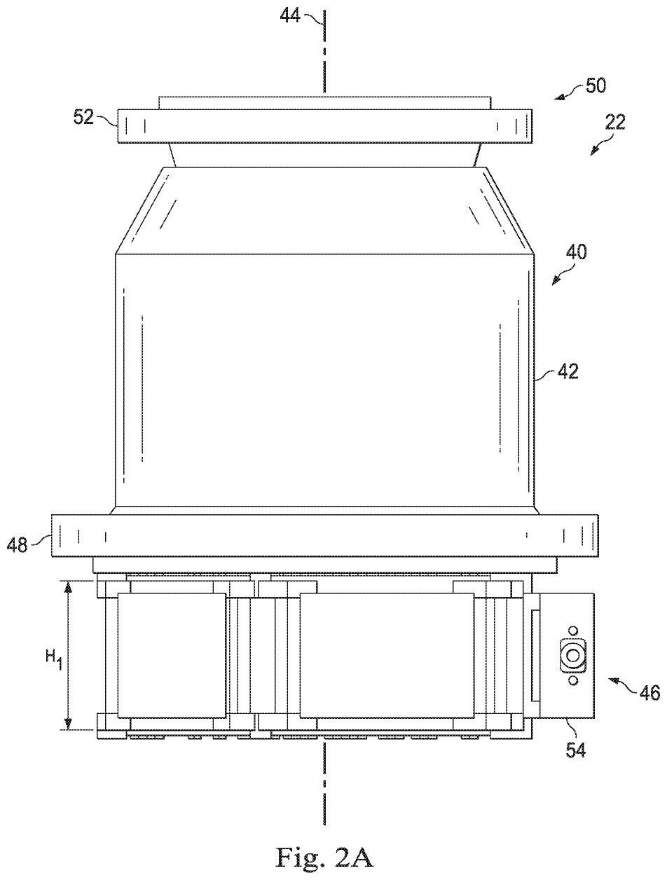

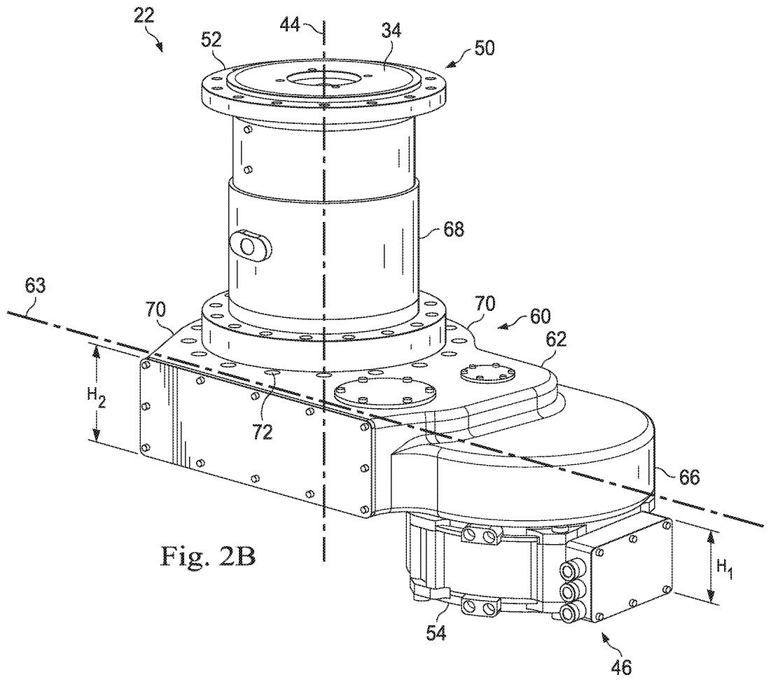

In FIG. 2A, one embodiment of an auger drive assembly 22 is illustrated in more detail. Specifically, in this embodiment, auger drive assembly 22 includes a reduction gearbox assembly 40 having a gearbox housing 42 generally disposed along a main gearbox axis 44 with an axial flux electric motor assembly 46 coupled to reduction gearbox assembly 40 adjacent a first end 48 of gearbox housing 42. Reduction gearbox assembly 40 includes a hub 50 that is rotatable relative to gearbox housing 42. A flange 52 may be provided at a distal end of hub 50 for securing hub 50 to the proximal end 34 of an auger shaft 30 (see FIG. 1).

As is clear from the figures and for the reasons discussed below, motor housing 54 of axial flux electric motor assembly 46 has a relatively low profile, as indicated by H1, compared to the length of reduction gearbox assembly 40 along main gearbox axis 44.

In FIG. 2B, another embodiment of an auger drive assembly 22 is illustrated in more detail. Specifically, in this embodiment, auger drive assembly 22 includes a reduction gearbox assembly 60 having a first gearbox housing 62 generally disposed along a gearbox axis 63 with an axial flux electric motor assembly 46 attached to reduction gearbox assembly 60 adjacent a first end 66 of first gearbox housing 62 and a second gearbox housing 68 generally disposed along main gearbox axis 44 and attached to first gearbox housing 62 adjacent a second end 70 of first gearbox housing 62. Reduction gearbox assembly 60 includes a hub 50 that is rotatable relative to second gearbox housing 68. A flange 52 may be provided at a distal end of hub 50 for securing hub 50 to the proximal end 34 of an auger shaft 30 (see FIG. 1).

As is clear from the figures and for the reasons discussed below, gearbox housing 62 has a low profile as indicated by height H2, particularly in some embodiments relative to second gearbox housing 68 extending along main gearbox axis 44. In this same vein, motor housing 54 of axial flux electric motor assembly 46 likewise has a relatively low profile as indicated by H1, and when attached to first gearbox housing 62, together maintain a relatively narrow profile allowing auger drive assembly 22 to be readily attached below a hopper 14 (see FIG. 1).

In one or more embodiments, reduction gearbox assembly 60 may include attachment mechanisms 72 for securing reduction gearbox assembly 60 to the base 18 of hopper 14 (see FIG. 1). In one or more embodiments, reduction gearbox assembly 60 may include attachment mechanisms 72 for securing reduction gearbox assembly 60 to a base plate 74 that mounts in base 18 of hopper 14 (see FIG. 1).

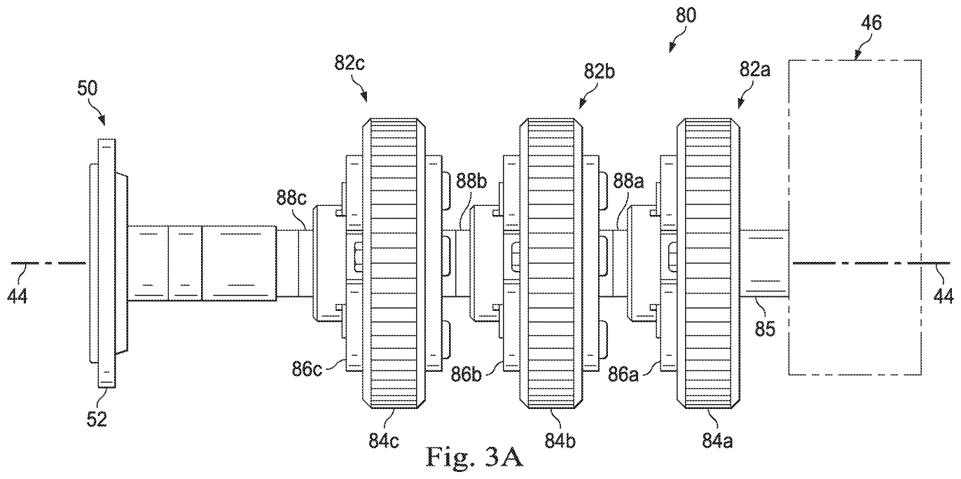

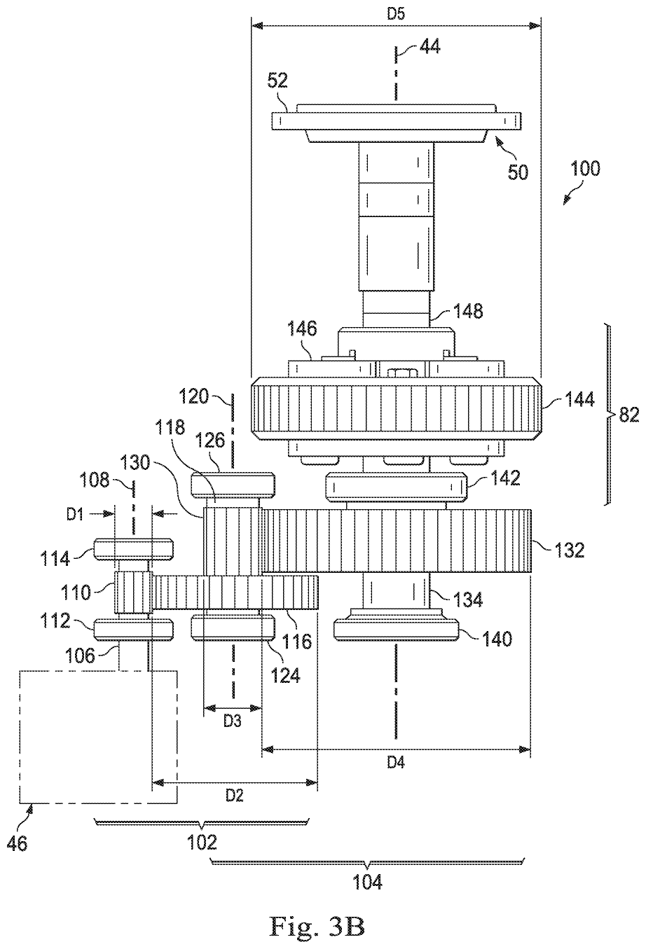

Turning to FIG. 3A, reduction gear train assembly 80 of reduction gearbox assembly 40 of FIG. 2A is illustrated. Reduction gear train assembly 80 is generally mounted within gearbox housing 42 (see FIG. 2A) to transfer rotary motion from axial flux electric motor assembly 46 (illustrated in dashed lines) to hub 50. Reduction gear train assembly 80 includes at least one planetary gear set assembly 82, but preferably reduction gear train assembly 80 is multi-stage having two or more planetary gear assemblies 82. In the illustrated embodiment, a three gear set assemblies 82 are illustrated as first, second and third planetary gear set assembly 82a, 82b, 82c, respectively.

Each planetary gear set assembly 82a, 82b, 82c generally includes a ring gear 84 within which is meshed two or more planetary gears (not shown) mounted on a carrier 86, with an output shaft 88 extending along main gearbox axis 44. A sun gear (not shown) is mounted on input shaft 85, also extending along main gearbox axis 44, driven by axial flux motor assembly 46 and meshes with the planetary gears (not shown) of the first planetary gear set assembly 82a in a manner well known in the art. Each carrier 86 includes an output shaft 88. The first output shaft 88a and the second output shaft 88b each include a sun gear (not shown), while the third output shaft 88c engages hub 50 or otherwise comprises hub 50 such that rotation of third carrier 86c rotates hub 50 and flange 52 relative to gearbox housing 42. In one or more embodiments, one or more of ring gears 84a, 84b, 84c are integrally formed as part of gearbox housing 42.

In one or more embodiments, the reduction of at least one of the first planetary gear set assembly 82a, the second planetary gear set assembly 82b and the third planetary gear set assembly 82c ranges from 5:1 to 6:1, while in other embodiments, two or more planetary gear set assemblies 82 have a reduction in the range of 5:1 to 6:1. In one or more embodiments, the reduction of at least one of the first planetary gear set assembly 82a, the second planetary gear set assembly 82b and the third planetary gear set assembly 82c is approximately 5.2:1.

In one or more embodiments, the reduction of planetary gear set assembly 82 ranges from 5:1 to 6:1. In one or more embodiments, the reduction of planetary gear set assembly 82 is approximately 5.2:1.

In one or more embodiments, the total reduction of reduction gear train assembly 80 having one or more planetary gear set assemblies 82 ranges from 154:1 to 150:1. In one or more embodiments, the total reduction of reduction gear train assembly 80 having one or more planetary gear set assemblies 82 is approximately 152.8:1.

Turning to FIG. 3B, an embodiment of reduction gear train assembly 100 of reduction gearbox assembly 60 shown in FIG. 2B is illustrated. Reduction gear train assembly 100 is generally mounted within first gearbox housing 62 and second gearbox housing 68 (see FIG. 2B) to transfer rotary motion from axial flux electric motor assembly 46 to hub 50. Reduction gear train assembly 100 includes at least one parallel shaft gearset assembly 102. In some embodiments, reduction gear train assembly 100 may also include at least one planetary gear set assembly 82. In the illustrated embodiment, reduction gear train assembly 100 includes a planetary gear set assembly 82 and a second parallel shaft gearset assembly 104.

Specifically shown in FIG. 3B, parallel shaft gearset assembly 102 generally includes an input shaft 106 extending along axis 108 from axial flux electric motor assembly 46 and on which is mounted a first gear 110. First gear 110 may be splined to input shaft 106. Input shaft 106 may be generally supported by shaft bearings 112, 114. In some embodiments, bearings 112, 114 may be ball bearings. Meshed with first gear 110 is a second gear 116. Second gear 116 is mounted on a gear shaft 118 extending along axis 120 and which gear shaft 118 is generally parallel with input shaft 106. Second gear 116 may be splined to gear shaft 118. Gear shaft 118 may be generally supported by shaft bearings 124, 126. In some embodiments, bearings 124, 126 may be tapered roller bearings. First gear 110 may be a pinion gear, a helix gear or otherwise, and may be selected to have a smaller diameter D1 than the diameter D2 of second gear 116. In one or more embodiments, the reduction of parallel shaft gearset assembly 102 ranges from 5:1 to 6:1. In one or more embodiments, the reduction of parallel shaft gearset assembly 102 is approximately 5.4:1.

Parallel shaft gearset assembly 104 generally includes a third gear 130 mounted on gear shaft 118. Third gear 130 may be splined to gear shaft 118. Meshed with third gear 130 is a fourth gear 132. Fourth gear 132 is mounted on a gear shaft 134 which gear shaft 134 is generally parallel with input shaft 106 and gear shaft 118. Fourth gear 132 may be splined to gear shaft 134. Gear shaft 134 may be generally supported by shaft bearings 140, 142. In some embodiments, bearings 140, 142 may be tapered roller bearings. Third gear 130 may be a pinion gear, a helix gear or otherwise, and may be selected to have a smaller diameter D3 than the diameter D4 of fourth gear 132. Third gear 130 may have a larger diameter D3 than the diameter D1 of first gear 110. In one or more embodiments, the reduction of parallel shaft gearset assembly 104 ranges from 5:1 to 6:1. In one or more embodiments, the reduction of parallel shaft gearset assembly 104 is approximately 5.4:1.

Planetary gear set assembly 82 generally includes a ring gear 144 within which is meshed two or more planetary gears (not shown) mounted on a carrier 146 from which extends an output shaft 148 extending along main gearbox axis 44. A sun gear (not shown) is mounted on gear shaft 134, also extending along main gearbox axis 44, and meshes with the planet gears (not shown) in a manner well known in the art. In this regard, is should be understood that this embodiment is not limited to a particular arrangement of a planetary gear set. In any event, output shaft 148 engages hub 50 or otherwise comprises hub 50 such that rotation of carrier 146 rotates hub 50 and flange 52. In some embodiments, hub 50 comprises carrier 146 such that planet gears are supported by hub 50. In one or more embodiments, the reduction of planetary gear set assembly 82 ranges from 5:1 to 6:1. In one or more embodiments, the reduction of planetary gear set assembly 82 is approximately 5.2:1.

In one or more embodiments, the total reduction of reduction gear train assembly 100 ranges from 154:1 to 150:1. In one or more embodiments, the total reduction of reduction gear train assembly 100 is approximately 152.8:1.

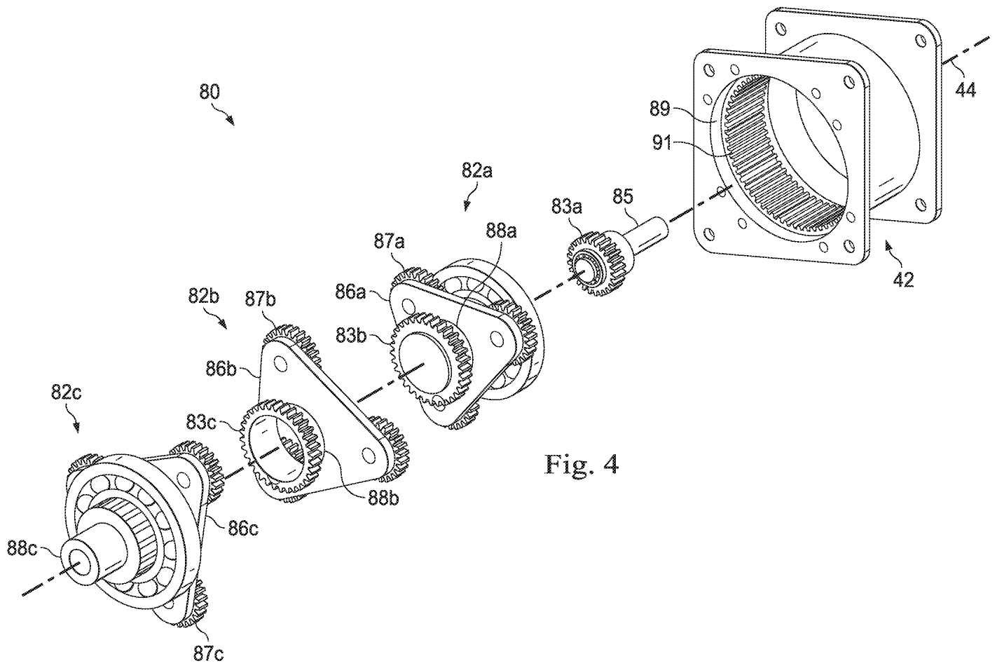

In FIG. 4, a partially exploded view of one embodiment of a reduction gear train assembly, such as reduction gear train assembly 80 of FIG. 3A, is shown extending along main gearbox axis 44, and has three planetary gear set assemblies 82a, 82b and 82c. It will be appreciated that while reduction gear train assembly 80 is illustrated as having three planetary gear set assemblies 82, in other embodiments, reduction gear train assembly 80 may have four or more planetary gear set assemblies 82. Likewise, as stated above, reduction gear train assembly 80 may have one or more planetary gear set assemblies 82 in yet other embodiments.

In any event, a first gear 83a, which is a sun gear, is shown mounted on an input shaft 85. Each planetary gear set assembly 82a, 82b, 82c generally includes a set of planetary gears 87 mounted on a carrier 86, with an output shaft 88 extending along main gearbox axis 44. The first sun gear 83a mounted on input shaft 85 meshes with the first set of planetary gears 87a supported by the first carrier 86a. Each carrier 86 includes an output shaft 88. The first output shaft 88a and the second output shaft 88b each include a sun gear 83b, 83c, respectively, mounted thereon or integrally formed therewith, while the third output shaft 88c engages hub 50 (not shown). Second sun gear 83b engages the second set of planetary gears 87b supported by the second carrier 86b, and third sun gear 83c engages the third set of planetary gears 87c supported by the third carrier 86c. In the illustrated embodiment, gearbox housing 42 includes an interior circumference 89 which is provided with teeth 91 to form a ring gear 84 that engages each of the first, second and third sets of planetary gears 87a, 87b, and 87c, respectively.

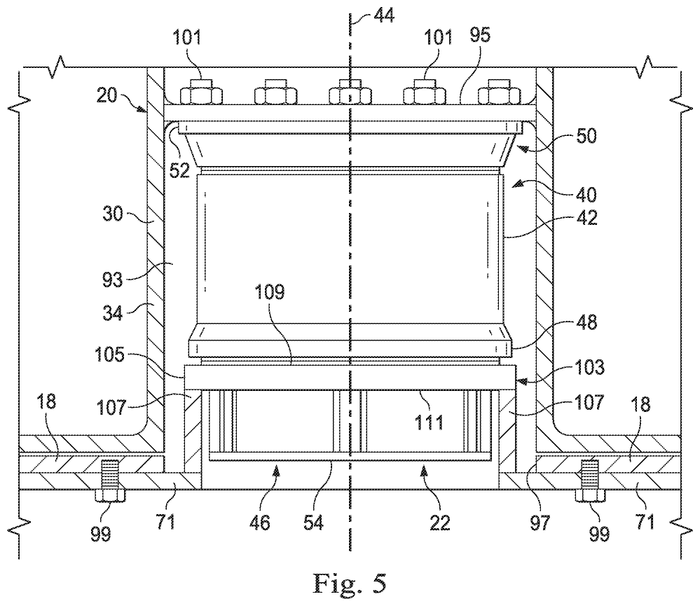

FIG. 5 illustrates a partial cut-away side view of an auger drive assembly 22 attached to an auger assembly 20. Auger assembly 20 includes an auger shaft 30 with a proximal end 34. Auger drive assembly 22 includes a reduction gearbox assembly 40 disposed along a main gearbox axis 44 and having a gearbox housing 42 and a hub 50 rotatable relative to gearbox housing 42 (via an output shaft 88c as described in FIG. 4). An axial flux electric motor assembly 46 is coupled to reduction gearbox assembly 40 adjacent a first end 48 of gearbox housing 42. A flange 52 may be provided at a distal end of hub 50 for securing hub 50 to auger shaft 30 such that rotation of the output shaft of reduction gear train assembly 80 (FIG. 4) rotates auger shaft 30. As shown, a cavity 93 may be formed in the proximal end 34 of auger shaft 30 for receipt of the auger drive assembly 22. In one or more embodiments, auger shaft 30 may be hollow as shown, and an auger plate 95 may be mounted within hollow auger shaft 30, spaced apart from proximal end 34, thereby forming cavity 93.

Because of the low profile of the auger drive assembly 22, and in particular, axial flux electric motor assembly 46, it will be appreciated that auger drive assembly 22 may be mounted so that a substantial portion of auger drive assembly 22 is within cavity 93, therefore limiting protrusion of auger drive assembly 22 into the undercarriage area of chassis 11 (see FIG. 1). Such an arrangement has the further benefit of protecting auger drive assembly 22 from damage, and in particular axial flux electric motor assembly 46. In the illustrated embodiment, a portion of base 18 of hopper 14 (see FIG. 1) is shown. An opening 97 in hopper base 18 allows auger drive assembly 22 to be positioned within cavity 93 of auger shaft 30. In one or more embodiments, auger drive assembly 22 may be mounted directly to hopper base 18. In other embodiments, such as is shown, auger drive assembly 22 may include a base plate 71 attached to reduction gearbox assembly 40, and base plate 71 may be subsequently attached to hopper base 18. Although not limited to any particular form of attachment, in the illustrated embodiment, fasteners 99 fix auger drive assembly 22 to hopper base 18. Rotatable hub 50 is likewise attached to auger shaft 30 to allow auger shaft 30 to rotate relative to hopper base 18. In the illustrated embodiment, fasteners 101 secure flange 52 of hub 50 to auger plate 95.

In one or more embodiments, base plate 71 may include a relief structure 103 formed by a top plate 105 supported by opposing sides 107. Relief structure 103 is disposed to extend into cavity 93 when base plate 71 is attached to hopper base 18. Reduction gearbox assembly 40 attaches to an upper surface 109 of top plate 105 and axial flux electric motor assembly 46 attaches to a lower surface 111 of top plate 105 so as to couple axial flux electric motor assembly 46 to reduction gearbox assembly 40. This embodiment allows axial flux electric motor assembly 46 to be replaced as desired without the need to disassemble reduction gearbox assembly 40 from auger assembly 20. As such, it will be appreciated that axial flux electric motor assembly 46 can readily be swapped out as different power or torque requirements arise for a particular auger drive assembly 22.

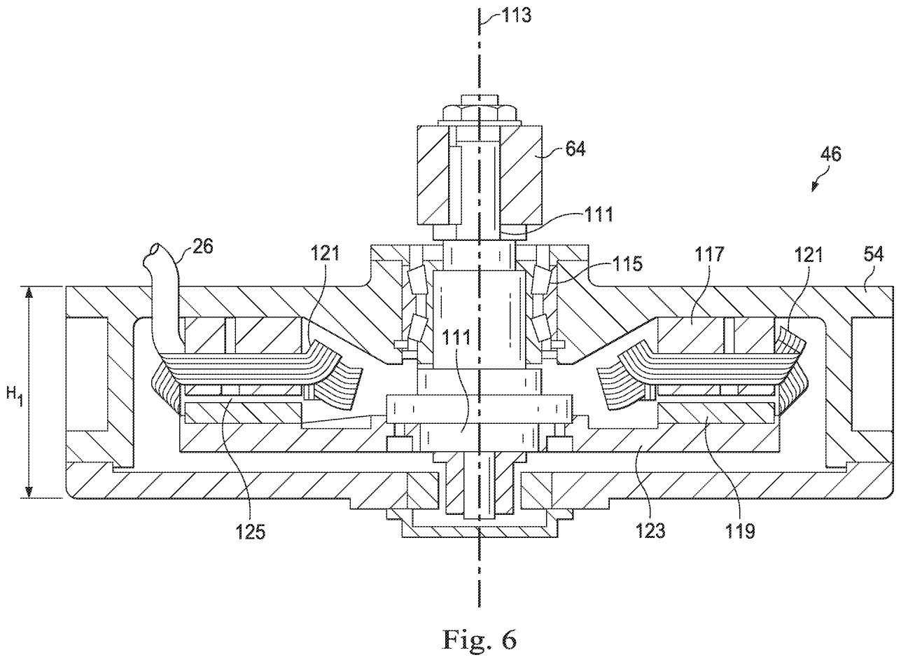

Turning to FIG. 6, axial flux motor assembly 46 is generally illustrated and includes a motor housing 54 in which a driveshaft 111 is supported on bearing 115. Driveshaft 111 extends along a driveshaft axis 113 and includes a first gear 64 mounted on driveshaft 111. Mounted on driveshaft 111 is at least one rotor 123. Spaced apart from the rotor 123 along the driveshaft axis 113 is at least one stator 117, thereby forming a gap 125 therebetween. Rotor 123 may include magnets 119 placed about a circumference of the rotor 123. Stator 117 may include windings 121 positioned about a circumference of the stator 117 and electrically communicating with cable 26.

In some embodiments, stator 117 may be fixed to the motor housing 54. The disclosure is not limited to a particular arrangement of axial flux motor, and in particular, the disclosure is not limited to a particular arrangement of rotors and stators. However, it will be appreciated that the axial flux motor assembly 46 has a generally narrow profile that permits it to be installed within limited confines, such as below a hopper 14 carried on a truck chassis 11 (see FIG. 1). Moreover, it will be appreciated that as desired to increase power or torque output of the axial flux motor assembly 46, the overall profile H₁ need not be significantly changed. Rather, the rotor 123 and stator 117 may be adjusted, such as by increasing the respective diameters of the rotor 123 and stator 117. In other words, increasing the rotor 123 and stator 117 diameters in order to achieve the desired power or torque for a particular feed mixing application need not result in a change in the low-profile characteristic of the overall axial flux motor assembly 46.

In one or more embodiments, driveshaft 111 is the same as or otherwise coupled to input shaft 85 of reduction gear train assembly 80 or to input shaft 106 of reduction gear train assembly 100, in which case first gear 64 is the first sun gear 83a of reduction gear train assembly 80 or the first gear 110 of reduction gear train assembly 100, respectively.

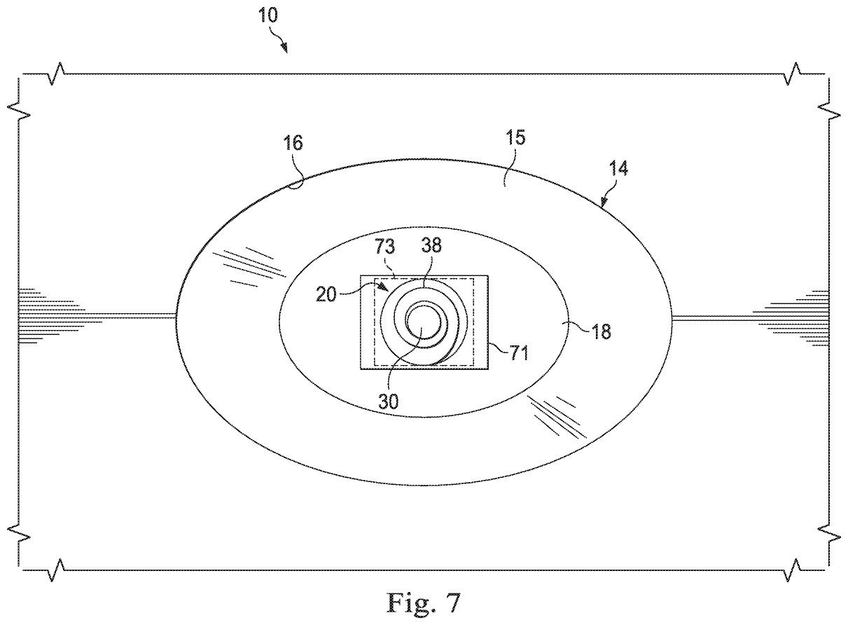

FIG. 7 is a top view of the feed mixer assembly 10. Hopper 14 is generally formed of a hopper wall 15 extending up from a hopper base 18 forming an opening 16 at the top of hopper 14. Auger assembly 20 extends vertically upward from hopper base 18 and includes at least one helical auger blade 38 mounted on an auger shaft 30. In some embodiments, hopper base 18 includes an opening 73 (shown in dashed lines) over which a base plate 71 may be mounted. In these embodiments, auger drive assembly 22 (see FIG. 1) can be mounted to the lower side of base plate 71. In order to change auger drive assembly 22, base plate 71 and the attached auger drive assembly 22 need simply be removed and replaced with a new base plate 71 having an attached auger drive assembly 22, thus eliminating the need and difficulty associated with replacing prior art gear boxes and drive mechanisms.

It will be appreciated that the feed mixer system as described herein eliminates the need for internal combustion engine driven feed mixers. Moreover, the auger drive assembly readily replaces the cumbersome and large right-angle gear box assemblies of the prior art, while permitting the required power and torque requirements of the feed mixer system to be maintained. The parallel gear set and planetary gear set arrangement allows the overall gear train to be much more compact than prior art gear trains while maintaining the same power torque transmission.

Thus, a feed mixer assembly has been described. In one or more embodiments, the feed mixer assembly includes a hopper having a base; an auger vertically extending from the hopper base and rotatably mounted relative to the base; a reduction gearbox assembly having an input shaft and an output shaft, the output shaft coupled to the auger; and an axial flux motor assembly having a driveshaft coupled to the input shaft of the reduction gearbox. In other embodiments, the feed mixer assembly includes a hopper having a base; an auger assembly vertically extending from the hopper base and rotatably mounted relative to the base; a reduction gearbox assembly having a reduction gear train assembly with an input shaft and an output shaft, the output shaft coupled to the auger, the reduction gearbox assembly further comprising a first planetary gear set assembly meshed with a second planetary gear set assembly, wherein the first planetary gear set assembly includes the input shaft and the second planetary gear set assembly includes the output shaft; and an axial flux motor assembly having a driveshaft coupled to the input shaft of the reduction gearbox assembly. In yet other embodiments, the feed mixer assembly includes a hopper having a base; an auger vertically extending from the hopper base and rotatably mounted relative to the base; a reduction gearbox assembly having a reduction gear train assembly with an input shaft and an output shaft, the output shaft coupled to the auger, the reduction gearbox assembly further comprising a first parallel shaft gearset assembly meshed with a second parallel shaft gearset assembly meshed with a planetary gear set assembly, wherein the first parallel shaft gearset assembly includes the input shaft and the planetary gear set assembly includes the output shaft; and an axial flux motor assembly having a driveshaft coupled to the input shaft of the first parallel shaft gearset assembly.

For any one of the forgoing feed mixer assembly embodiments, the following elements may be included, alone or in combination with any other elements:
A vehicle having a chassis to which the hopper is mounted.
An electrical power source electrically coupled to the axial flux motor assembly.
The electrical power source comprises an inverter.
The electrical power source comprises at least one battery and an inverter.
A base plate to which the reduction gearbox assembly and axial flux motor assembly are mounted, the base plate being attached to the hopper base.
A base plate fixed to the base of the hopper, the base plate comprising a mounting relief structure formed of a top plate supported by opposing sides, wherein the reduction gearbox assembly is mounted on a first side of the top plate of the mounting relief structure and the axial flux motor assembly is mounted on a second side of the top plate.
The reduction gearbox assembly comprises a gearbox housing in which is mounted a reduction gear train assembly having an input shaft and an output shaft, the output shaft coupled to the auger assembly, the reduction gearbox assembly further comprising a first parallel shaft gearset assembly meshed with a second parallel shaft gearset assembly meshed with a planetary gear set assembly, wherein the first parallel shaft gearset assembly includes the input shaft and the planetary gear set assembly includes the output shaft.
The reduction gearbox assembly comprises a gearbox housing in which is mounted a reduction gear train assembly having an input shaft and an output shaft, the output shaft coupled to the auger assembly, the reduction gearbox assembly further comprising a first parallel shaft gearset assembly meshed with a second parallel shaft gearset assembly, wherein the first parallel shaft gearset assembly includes the input shaft and the second parallel gearset assembly includes the output shaft.
The reduction gearbox assembly comprises a gearbox housing in which is mounted a reduction gear train assembly having an input shaft and an output shaft, the output shaft coupled to the auger, the reduction gearbox assembly further comprising a first parallel shaft gearset assembly meshed with a planetary gear set assembly, wherein the first parallel shaft gearset assembly includes the input shaft and the planetary gear set assembly includes the output shaft.
The axial flux motor assembly comprises a motor housing in which is rotatably mounted a driveshaft; a rotor mounted to the driveshaft; a stator spaced apart from the rotor and mounted around the driveshaft.
A second auger assembly vertically extending from the hopper base and rotatably mounted to the base; a second reduction gearbox assembly having an input shaft and an output shaft, the output shaft coupled to the second auger assembly; and a second axial flux motor assembly having a driveshaft coupled to the input shaft of the second reduction gearbox assembly.
The total reduction of reduction gear train assembly ranges from 154:1 to 150:1.
The total reduction of reduction gear train assembly is approximately 152.8:1.
The first parallel shaft gearset assembly comprises an input shaft extending along a first axis and on which is mounted a first gear meshed with a second gear mounted on a first gear shaft extending along a second axis generally parallel with the first axis.
The reduction of first parallel shaft gearset assembly ranges from 5:1 to 6:1.
The reduction of first parallel shaft gearset assembly is approximately 5.4:1.
The second parallel shaft gearset assembly comprises a third gear on the first gear shaft and meshed with a fourth gear mounted on a second gear shaft extending along a third axis and which is generally parallel with the first axis.
The reduction of second parallel shaft gearset assembly ranges from 5:1 to 6:1.
The reduction of second parallel shaft gearset assembly is approximately 5.4:1.
The planetary gear set assembly comprising a ring gear within which is meshed two or more planetary gears mounted on a carrier from which extends an output shaft; and a sun gear mounted on the second gear shaft.
The reduction of planetary gearset assembly ranges from 5:1 to 6:1.
The reduction of planetary gearset assembly is approximately 5.2:1.
A third planetary gear set assembly meshed with between the first and second planetary gear assemblies.
The auger assembly comprises an auger shaft having a first end and a second end, with a cavity formed in the second end of the auger shaft, wherein at least a portion of the reduction gearbox assembly is mounted in the cavity.
The auger assembly comprises an auger shaft having a first end and a second end, with a cavity formed in the second end of the auger shaft, wherein the reduction gearbox assembly is mounted in the cavity and at least a portion of the axial flux motor assembly is mounted in the cavity.
An auger plate mounted within the auger shaft to form the cavity, wherein the output shaft of the reduction gearbox assembly engages the auger plate to rotate the auger shaft.
The reduction gearbox assembly comprises a gearbox housing in which the reduction gear train assembly is mounted and a gearbox hub, rotatable relative to the gearbox housing, wherein the output shaft engages the rotatable hub.
The reduction gearbox assembly comprises a gearbox housing in which the reduction gear train assembly is mounted and a gearbox hub, rotatable relative to the gearbox housing, wherein the output shaft engages the rotatable hub.
The rotatable hub attaches to the auger plate.
A base plate to which the gearbox housing and axial flux motor assembly are attached.
The base plate is removably attached to the base of the hopper.
The base plate is fixed to the base of the hopper.
The base plate comprises a mounting relief structure formed of a top plate supported by opposing sides.
The auger assembly comprises an auger shaft having a first end and a second end, with a cavity formed in the second end of the auger shaft, wherein the reduction gearbox assembly is mounted on a first side of the top plate of the mounting relief structure and the axial flux motor assembly is mounted on a second side of the top plate, and wherein the relief structure extends into the cavity of the auger assembly when the base plate is attached to the base of the hopper.
The rotatable hub is fixedly attached to the auger assembly and the gearbox housing is fixed relative to the base of the hopper.

While various embodiments have been illustrated in detail, the disclosure is not limited to the embodiments shown. Modifications and adaptations of the above embodiments may occur to those skilled in the art. Such modifications and adaptations are in the spirit and scope of the disclosure.

What is claimed is:

1. A feed mixer assembly comprising:
a hopper having a base;
an auger assembly vertically extending from the hopper base and rotatably mounted relative to the base;
a reduction gearbox assembly having an input shaft and an output shaft, the output shaft coupled to the auger; and
an axial flux motor assembly having a driveshaft coupled to the input shaft of the reduction gearbox.

2. The feed mixer assembly of claim 1, further comprising a vehicle having a chassis to which the hopper is mounted.

3. The feed mixer of claim 1, further comprising an electrical power source electrically coupled to the axial flux motor assembly.

4. The feed mixer of claim 1, further comprising a base plate fixed to the base of the hopper, the base plate comprising a mounting relief structure formed of a top plate supported by opposing sides, wherein the reduction gearbox assembly is mounted on a first side of the top plate of the mounting relief structure and the axial flux motor assembly is mounted on a second side of the top plate.

5. The feed mixer of claim 1, wherein the axial flux motor assembly comprises a motor housing in which is rotatably mounted a driveshaft; a rotor mounted along the driveshaft; and a stator spaced axially apart from the rotor along the driveshaft.

6. The feed mixer of claim 1, wherein the reduction gearbox assembly comprises a gearbox housing in which is mounted a reduction gear train assembly having an input shaft and an output shaft, the output shaft coupled to the auger assembly, the reduction gearbox assembly further comprising a first parallel shaft gearset assembly meshed with a second parallel shaft gearset assembly meshed with a planetary gear set assembly, wherein the first parallel shaft gearset assembly includes the input shaft and the planetary gear set assembly includes the output shaft.

7. The feed mixer of claim 1, wherein the reduction gearbox assembly comprises a gearbox housing in which is mounted a reduction gear train assembly having an input shaft and an output shaft, the output shaft coupled to the auger assembly, the reduction gearbox assembly further comprising a first parallel shaft gearset assembly meshed with a second parallel shaft gearset assembly, wherein the first parallel shaft gearset assembly includes the input shaft and the second parallel gearset assembly includes the output shaft.

8. The feed mixer of claim 1, wherein the reduction gearbox assembly comprises a gearbox housing in which is mounted a reduction gear train assembly having an input shaft and an output shaft, the output shaft coupled to the auger, the reduction gearbox assembly further comprising a first parallel shaft gearset assembly meshed with a planetary gear set assembly, wherein the first parallel shaft gearset assembly includes the input shaft and the planetary gear set assembly includes the output shaft.

9. The feed mixer of claim 1, wherein the auger assembly comprises an auger shaft having a first end and a second end, with a cavity formed in the second end of the auger shaft, wherein the reduction gearbox assembly is mounted in the cavity and at least a portion of the axial flux motor assembly is mounted in the cavity.

10. The feed mixer of claim 1, further comprising a second auger assembly vertically extending from the hopper base and rotatably mounted to the base; a second reduction gearbox assembly having an input shaft and an output shaft, the output shaft coupled to the second auger assembly; and a second axial flux motor assembly having a driveshaft coupled to the input shaft of the second reduction gearbox assembly.

11. A feed mixer assembly comprising:
a hopper having a base;
an auger assembly vertically extending from the hopper base and rotatably mounted relative to the base;
a reduction gearbox assembly having a reduction gear train assembly with an input shaft and an output shaft, the output shaft coupled to the auger, the reduction gearbox assembly further comprising a first planetary gear set assembly meshed with a second planetary gear set assembly, wherein the first planetary gear set assembly includes the input shaft and the second planetary gear set assembly includes the output shaft; and
an axial flux motor assembly having a driveshaft coupled to the input shaft of the reduction gearbox assembly.

12. The feed mixer assembly of claim 11, further comprising a vehicle having a chassis to which the hopper is mounted.

13. The feed mixer of claim 11, further comprising an electrical power source electrically coupled to the axial flux motor assembly.

14. The feed mixer of claim 1, further comprising a base plate fixed to the base of the hopper, the base plate comprising a mounting relief structure formed of a top plate supported by opposing sides, wherein the reduction gearbox assembly is mounted on a first side of the top plate of the mounting relief structure and the axial flux motor assembly is mounted on a second side of the top plate.

15. The feed mixer of claim 11, wherein the axial flux motor assembly comprises a motor housing in which is rotatably mounted a driveshaft; a rotor mounted along the driveshaft; and a stator spaced axially apart from the rotor along the driveshaft.

16. The feed mixer of claim 11, wherein the auger assembly comprises an auger shaft having a first end and a second end, with a cavity formed in the second end of the auger shaft, wherein the reduction gearbox assembly is mounted in the cavity and at least a portion of the axial flux motor assembly is mounted in the cavity.

17. A feed mixer assembly comprising:
a hopper having a base;
an auger vertically extending from the hopper base and rotatably mounted relative to the base;
a reduction gearbox assembly having a reduction gear train assembly with an input shaft and an output shaft, the output shaft coupled to the auger, the reduction gearbox assembly further comprising a first parallel shaft gearset assembly meshed with a second parallel shaft gearset assembly meshed with a planetary gear set assembly, wherein the first parallel shaft gearset assembly includes the input shaft and the planetary gear set assembly includes the output shaft; and
an axial flux motor assembly having a driveshaft coupled to the input shaft of the first parallel shaft gearset assembly.

18. The feed mixer of claim 17, wherein the axial flux motor assembly comprises a motor housing in which is rotatably mounted a driveshaft; a rotor mounted along the driveshaft; and a stator spaced axially apart from the rotor along the driveshaft.

19. The feed mixer of claim 18, further comprising an electrical power source electrically coupled to the axial flux motor assembly.

20. The feed mixer of claim 19, wherein the auger assembly comprises an auger shaft having a first end and a second end, with a cavity formed in the second end of the auger shaft, wherein the reduction gearbox assembly is mounted on a first side of the top plate of the mounting relief structure and the axial flux motor assembly is mounted on a second side of the top plate, and wherein the relief structure extends into the cavity of the auger assembly when the base plate is attached to the base of the hopper.
